(19) United States
(12) Patent Application Publication
(10) Pub. No.: US 2016/0163151 A1
(43) Pub. Date: Jun. 9, 2016

(54) METHOD AND SYSTEM FOR DETERMINING A WINNER OF A LOTTERY

(71) Applicant: WON IN A MILLION PTY LTD, Melbourne, Victoria (AU)

(72) Inventors: Victor SUSMAN, Toorak (AU); Kennedy BAKER, Bend Of Islands (AU); Benjamin CANAIDER, Malvern (AU)

(73) Assignee: WON IN A MILLION PTY LTD, Melbourne, Victoria (AU)

(21) Appl. No.: 14/899,635

(22) PCT Filed: Jun. 20, 2013
(86) PCT No.: PCT/AU2013/000663

§ 371 Date: Dec. 18, 2015

(51) Int. Cl. G07F 17/32; G06Q 50/34

(52) U.S. Cl. CPC G07F 17/3227; G06Q 50/34; G07F 17/329; G07F 17/3272; G07F 17/323

(57) ABSTRACT

There is disclosed a computer-implemented method of determining a winner of a lottery, including: (i) generating data representing tickets purchased by users, said data including, for each ticket, a value for each of one or more variables and a status indicator indicating whether the ticket is live or dead; (ii) selecting a group of live tickets on the basis of a value or range of values for at least one of the one or more variables; (iii) setting the status indicator to dead for each ticket within the selected group; and (iv) iterating over steps (ii) and (iii) to progressively reduce the number of live tickets in groups until one or more threshold numbers of live tickets is reached and/or until a single live ticket remains.

### TECHNICAL FIELD

The present invention relates to a method and system for determining a winner of a lottery.

### BACKGROUND

It is known for entities such as gaming authorities to conduct games of chance such as lotteries. In one known form of lottery, contestants purchase- tickets and choose (or have randomly selected for them in a “quick pick” system) a subset of numbers from an available set of two-digit numbers. One or more winners are then determined by randomly drawing a reference subset of numbers, which can be matched against numbers allocated to a contestant's ticket. Other types of lottery in which one or more winning numbers (or sets of numbers) are randomly drawn are also known.

It is typical for the random draw to be conducted “live”, for example in a television studio, and the results to be broadcast to viewers. Since contestants may purchase multiple tickets, each associated with different sets of numbers, it may not be immediately obvious to a contestant as the random numbers are drawn whether or not any of their tickets has a chance of winning. Further, the live draw holds interest only for those who have actually purchased tickets, and not for a wider audience.

It would be desirable to provide a method of conducting a lottery which provides enhanced entertainment for contestants and/or the wider public, or at least to provide a useful alternative.

### SUMMARY OF THE INVENTION

In accordance with one aspect of the present invention, there is provided a computer-implemented method of determining a winner of a lottery, including:
(i) generating data relating to tickets purchased by users, said data including, for each ticket, a value for each of one or more variables and a status indicator indicating whether the ticket is live or dead;
(ii) selecting a group of live tickets on the basis of a value or range of values for at least one of the one or more variables;
(iii) setting the status indicator to dead for each ticket within the selected group; and
(iv) iterating over steps (ii) and (iii) to progressively reduce the number of live tickets in groups until one or more threshold numbers of live tickets is reached and/or until a single live ticket remains.

In another aspect of the present invention, there is provided a system for determining a winner of a lottery, including at least one computer processor configured to perform the method of the first aspect of the invention.

In a third aspect, the invention provides a system for determining a winner of a lottery, including:
means for generating data representing tickets purchased by users, said data including, for each ticket, a value for each of one or more variables and a status indicator indicating whether the ticket is live or dead; and
means for iteratively:
   selecting a group of live tickets on the basis of a value or range of values for at least one of the one or more variables; and
   setting the status indicator to dead for each ticket within the selected group,
to thereby progressively reduce the number of live tickets in groups until one or more threshold numbers of live tickets is reached and/or until a single live ticket remains.

In a fourth aspect of the invention, there is provided a computer program product for determining a winner of a lottery, including program instructions which, when executed, cause one or more computer processors to perform the method of the first aspect of the invention.

In a fifth aspect, the invention provides a computer readable data storage device including the computer program product of the fourth aspect of the invention.

### BRIEF DESCRIPTION OF THE DRAWINGS

Certain embodiments of the present invention are hereafter described, by way of non-limiting example only, with reference to the accompanying drawings in which:

FIG. 1 is a block diagram of a system for determining a winner of a lottery;

FIG. 2 is a block diagram of an exemplary computer system for use with the system of FIG. 1; and

FIGS. 3 to 8 are flow charts showing steps of an exemplary process implemented by the system of FIG. 1.

### DETAILED DESCRIPTION

Embodiments of the invention provide an online lottery which may incorporate social media, share-trading, convergent technologies and brand and celebrity creation and endorsement. The online lottery may be conducted in conjunction with a game show which is broadcast on television and/or via the internet.

In one embodiment, the lottery runs for a predetermined period, for example six weeks, to determine a single winner of a grand prize from an initial pool of entries. The initial pool may be made arbitrarily large. In the following examples, the initial pool comprises 1,000,000 entries (live tickets).

In the first three phases of the competition the number of live tickets is reduced from 1,000,000 to 800 (for example) in three phases of elimination rounds. Further elimination rounds are then conducted and the winner of the grand prize is determined at the end of a predetermined cycle (for example, a six-week cycle).

The winning ticket is not determined by randomly drawing a specific number (for example, from the set of numbers corresponding to the initial pool of live tickets). Nor, as in many types of lotto games, are a series of numbers drawn and then matched to an individual ticket. The present inventors believe that neither of these two approaches is able to provide information to an audience in a sufficiently rapid and efficient manner.

The invention, in at least some of its embodiments, is specifically designed to allow rapid transmission of updated ticket status data from the operator of the lottery (or an associated entity) to an audience connected by remote devices such as TVs, computers connected to the operator's system over a network connection, set top boxes, or mobile telephony devices.

System Overview

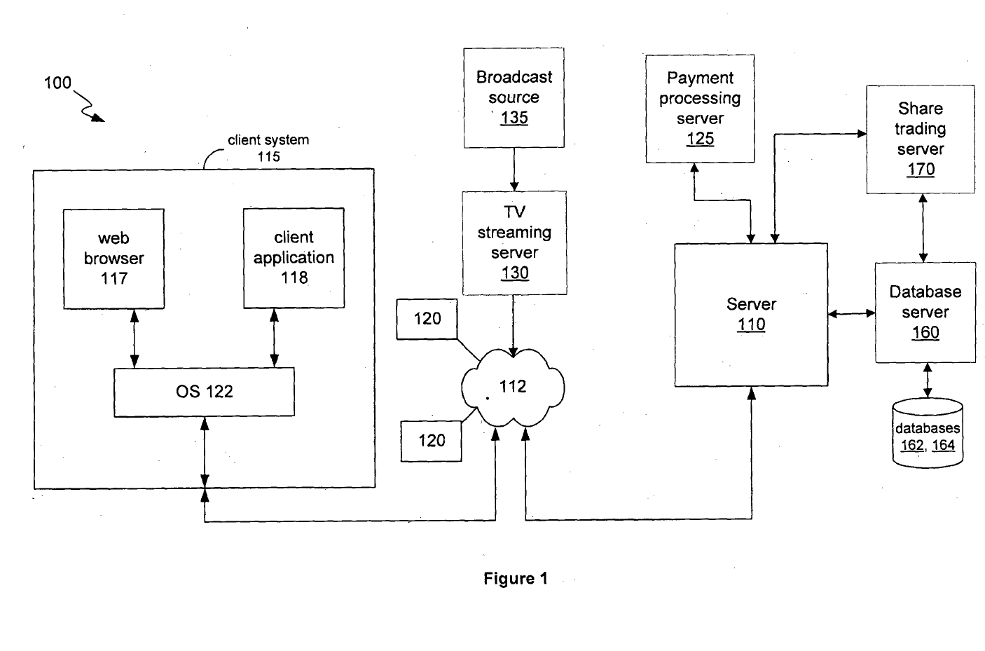

Referring initially to FIG. 1, there is shown a system 100 for determining a winner of a lottery. The system includes a computer system (server) 110 in communication with a client system 115 via a data communication network 112, such as the Internet. Further, similar client systems 120 may also be simultaneously in communication with server 110. Server 110 is responsible for the overall control and coordination of the process described herein and may be in communication with various other components (hardware and/or software) which handle parts of the process.

The system 100 includes a TV streaming server 130 which receives video and audio data from a broadcast source 135 for broadcast over the Internet 112. The broadcast source 135 may be an analog or digital source such as a radio frequency transmitter or transmitters transmitting signals originating from a TV studio. Alternatively, server 110 may itself be the source of video and audio data for the streaming server 130, having first received and processed signals received from the TV studio, for example. In some embodiments, data transmitted by streaming server 130 may also incorporate data from databases 162, 164 which are in communication with server 110. The TV streaming server 130 may be a standard computer system running one or more software modules which convert the video and audio data to a stream, or may be a standard computer system in communication with a dedicated streaming device such as an IMX i2410 Live TV MatrixCast Streaming Server of MatrixCast Technologies, Inc. (California).

The server 110 is in communication with a database server 160 which in turn is in communication with databases 162, 164 which store data used by the system, including data relating to user accounts, tickets and trading of shares in tickets as will later be described. It will also be appreciated that server 110 may be directly in communication with databases 162, 164.

Further included in system 100 is a share trading server 170, in communication with server 110.

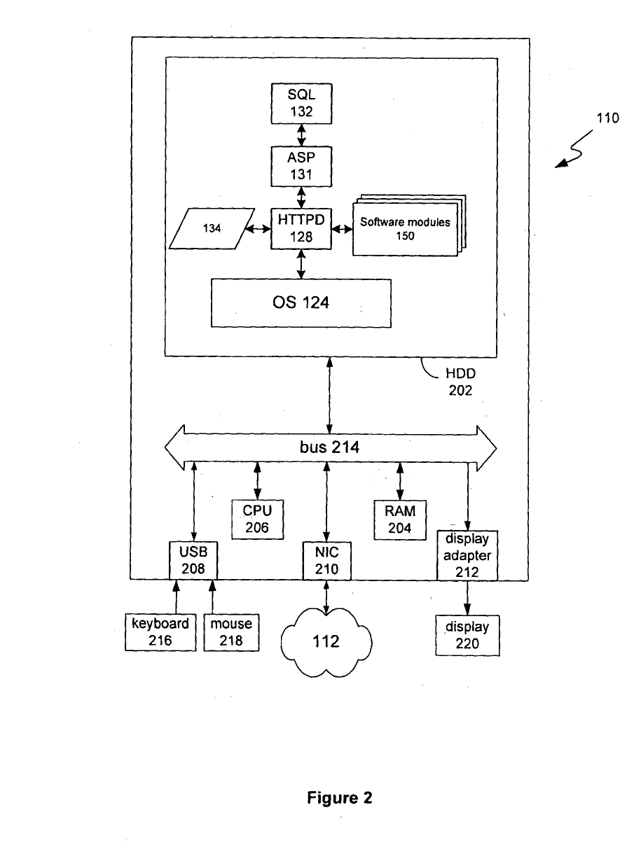

In the described embodiment, the server 110 is a standard computer system such as a commercially available personal computer or server computer system based on a 32-bit or 64-bit Intel architecture, and the processes and/or methods executed or performed by the system 100 are implemented in the form of programming instructions of one or more software components or modules 150 stored on non-volatile (e.g., hard disk) computer-readable storage 202 associated with the computer system 110, as shown in FIG. 2. At least parts of the software modules 150 could alternatively be implemented as one or more dedicated hardware components, such as application-specific integrated circuits (ASICs) and/or field programmable gate arrays (FPGAs).

The software modules 150 include at least the following: a contestant registration module, a user authentication module, a ticket sales module, a ticket elimination module, and a share trading module.

The computer system 110 includes at least one or more of the following standard, commercially available, computer components, all interconnected by a bus 214: random access memory (RAM) 204, at least one computer processor 206, and external computer interfaces. The external computer interfaces include a network interface connector (NIC) 210 which connects the computer system 110 to a data communications network such as the Internet 112.

The computer system 110 includes a plurality of standard software modules, including: an operating system (OS) 124 (e.g., Linux or Microsoft Windows); web server software 128 (e.g., Apache, available at http://www.apache.org); scripting language modules 131 (e.g., personal home page or PHP, available at http://www.php.net, or Microsoft ASP); and structured query language (SQL) modules 132 (e.g., MySQL, available from http://www.mysql.com), which allow data to be stored in and retrieved/accessed from an SQL databases 162, 164.

Together, the web server 128, scripting language 131, and SQL modules 132 provide the computer system 110 with the general ability to allow users of the Internet 112 with standard computing devices equipped with standard web browser software to access the computer system 110 and in particular to provide data to and receive data from the databases 162, 164. It will be understood by those skilled in the art that the specific functionality provided by the system 110 to such users is provided by scripts accessible by the web server 128, including the one or more software modules 150 implementing the processes 400, 500, 600, 700, and also any other scripts and supporting data 134, including markup language (e.g., HTML, XML) scripts, PHP (or ASP), and/or CGI scripts, image files, style sheets, and the like.

Client system 115 includes standard software modules including an operating system (OS) 122 and a web browser 117. The client system 115 may also include a client application module 118 for communicating with server 110.

Process Overview

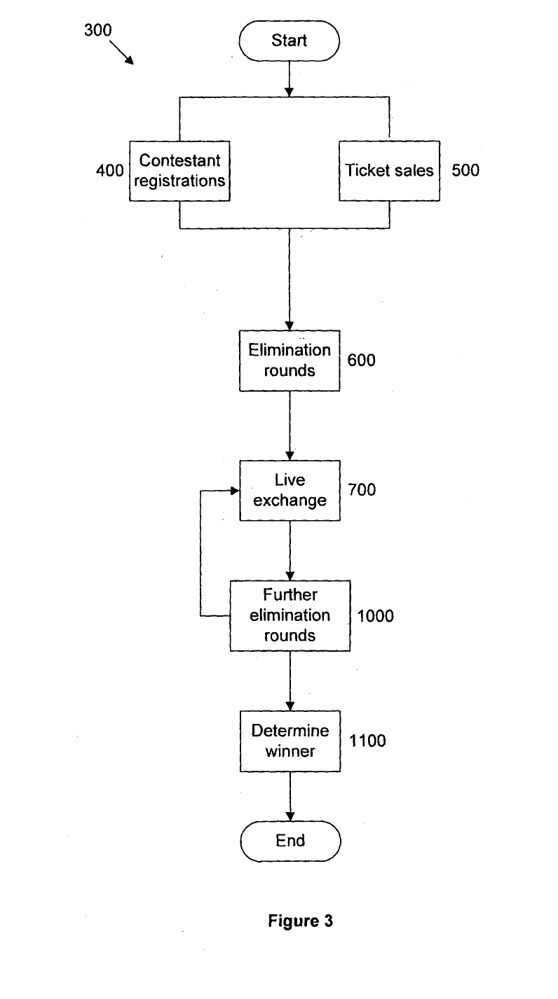

An overview of a computerised process 300 for determining a winner of a lottery is shown in FIG. 3.

The process allows for registrations for users of the system (contestants) at step 400. Tickets are offered for sale to registered contestants at step 500 (whilst also allowing ongoing registrations of new contestants). At a predetermined point, for example when all available tickets are sold or at a fixed time prior to commencement of the first random draw (whichever occurs first), ticket sales end.

Then, a series of elimination rounds is conducted at step 600 to progressively eliminate groups of tickets from the initial pool of purchased tickets until a threshold number of non-eliminated (live) tickets is reached, as will be described in more detail below. On reaching this threshold number, a “live exchange” process is commenced (step 700) whereby holders of the remaining live tickets may accept bids from registered contestants for shares in their tickets. Shares may be traded between contestants.

The “live exchange” process may run for a predetermined time and may be interspersed with further elimination rounds (step 1000).

At a further threshold number of remaining live tickets, or at a predetermined time, the “live exchange” process 700 terminates and a final elimination phase 1100 is conducted in order to determine a winner of a grand prize. For example, the final elimination 1100 may involve a random selection of a single winning ticket from the remaining live tickets, or may involve one-at-a-time or few-at-a-time elimination of the remaining live tickets until a single winning ticket remains. The final elimination 1100 may be filmed ‘live’ and broadcast via streaming server 130 and/or by web server 128.

Process Details

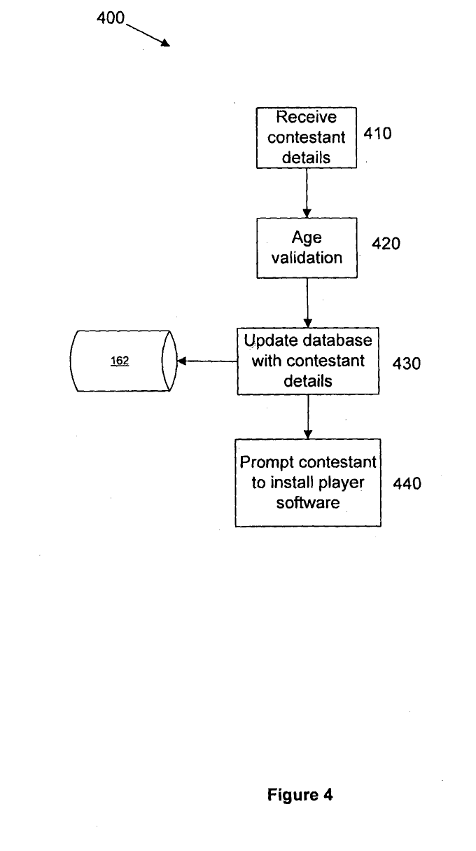

In step 400 of the process 300, as shown in FIG. 4, a contestant registration module (of modules 150) provides for registration of a contestant by serving, to a web browser 117 of the contestant's system 115, a web page including a series of data entry fields. At step 410, the contestant registration module receives the contestant details entered in the data entry fields and then performs an age verification step 420 to confirm that the contestant meets a legal age requirement for participating in lotteries and the like (for example, 18 years and over). This may be as simple, as example, as serving a web page including a prompt to the contestant to check a box or click a button to confirm they are of the legal age.

The contestant registration module stores the contestant details in a user database 162 (step 430). The stored contestant details may include a user name, encrypted password information, personal details of the user such as contact information, and a verification question/answer for resetting the user's password. Age verification information (for example, date of birth and a flag indicating that the user has confirmed the age requirement) may also be stored.

Typically, the registration process 400 will include a step (not shown) of recording banking details for the contestant, to enable payout of prizes and/or payment of funds for shares in a live ticket during the live exchange process 700 as will later be described. The banking details may be used by payment processing server 125 in order to perform transactions as required.

Once the user has been registered, the process 400 may prompt the user to install custom software modules (player software) 118 on the user's system 115 (step 440). Alternatively, the player software may be browser-based, for example being implemented in javascript or the like which is executable or interpretable by web browser 117.

The contestant registration process 400 may be executed at any time during the overall process 300, for example either before or after sales of tickets have commenced and up until the first of the elimination rounds (step 600) has commenced.

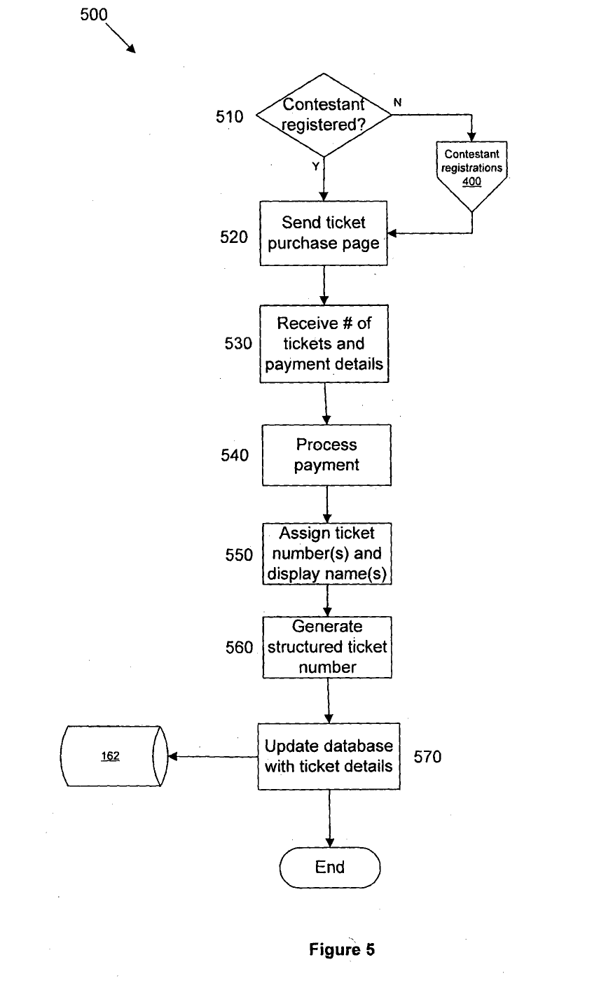

Referring now to FIG. 5, the steps of the ticket sale process 500 are shown. The ticket sales module executing process 500 first checks whether the contestant is registered, and if not, branches to contestant registration process 400. For a previously-registered contestant, a ticket purchase page is generated and sent to the contestant's web browser 117 (step 520). The contestant selects the number of tickets desired, and payment details (such as credit card details). It will also be appreciated that the payment details may be stored as part of the contestant details in user database 162 to obviate the need for the contestant to enter them at each ticket purchase.

The number of tickets and payment details are received by the ticket sales module at step 530, and the payment is then processed (step 540), for example by transmitting data representing the payment details to a payment processing module in communication with a third party payment processing system 125 over Internet connection 112 in a manner known in the art.

On successful processing of the payment, the ticket sales module then assigns a unique ticket number (step 550) to each purchased ticket. The process 500 may offer an option for the contestant to choose a name for each ticket, for ease of remembering details of each ticket as will later be explained. The ticket name should also be unique, and this may be checked by process 500 by querying database 162 on receiving the contestant's name selection(s) (not shown). The process 500 may also assign unique ticket names on behalf of the contestant, for example combinations of the contestant's user name with random numbers and optionally the date of sale or the date of the relevant draw.

At step 560, the ticket sales module assigns values for a number of variables to each purchased ticket. The variables may be categorical variables, or a mixture of categorical and numerical (discrete or continuous) variables. In one example, a first variable is “colour” while four further variables are numerical group identifiers of varying size. The variables define a hierarchy of group identifiers which can be used to progressively eliminate live tickets as will be described below. One or more of the variables may be “hidden” variables—that is, their values are known to the server system 110 and stored in database 162, but are not visible to contestants.

In one example, the total number of tickets available is 1,000,000 and the variables/group identifiers are as shown in Table 1 below. Each variable in this example is a 1-, 2- or 3-digit number representing a group.

TABLE 1
example variable types

| Variable | Type | Digits | Range | Comments |
|---|---|---|---|---|
| Colour | Integer | 1 | 1-8 | Each number is associated |
| | | | | with a colour. Can be chosen |
| | | | | by contestant (possibly with |
| | | | | restriction) or randomly |
| | | | | generated |
| Grouping | Integer | 3 | 001-125 | number between 1 and 125. |
| Level 1(to | | | | Typically chosen by system |
| get to 1,000) | | | | but may be user-selectable. |
| Grouping | Integer | 1 | 1-5 | number between 1 and 5, |
| Level 2 (to | | | | chosen by system - may |
| get to 800) | | | | be hidden variable |
| Grouping | Integer | 2 | 01-16 | number between 01 and 16 -- |
| Level 3 (to | | | | may be hidden variable |
| get to 50) | | | | |
| Grouping | Integer | 1 | 1-5 | number between 1 and 5 - |
| Level 4 (to | | | | may be hidden variable |
| get to 10) | | | | |
| check digits | Integer | 2 | 0-99 | validation digits |

A structured ticket number may be generated from the values of the above variables, for example by converting the values to characters and concatenating the characters into a single string. So, for example, for a ticket having Colour=3, Grouping Level 1=77, Grouping Level 2=2, Grouping Level 3=9 and Grouping Level 4=5, the structured ticket number would be “30772095”. Delimiting characters, such as a hyphen, may be introduced into the structured ticket number for ease of reading, for example “3-077-2-09-5”.

The check digits serve as an authentication measure for the ticket number and may be generated by performing a series of mathematical operations, known only to the system 110, on each of the digits of the structured ticket number. For example, the sum of the digits could be multiplied by 7, the result divided by 31, and the result of the division truncated at two decimal places with the two digits of the fractional part then being used as the check digits. The transformation between structured ticket number and check digits could be periodically changed, so that, for example, the particular series of operations would be associated with a particular draw of the lottery, a particular purchase time, or so on. The check digits may thereby be used to detect whether an entered ticket number is valid or not.

Step 560 may allow the contestant to choose the “colour” of each ticket, from 8 available colours, for example. Alternatively, the contestant may request the colour to be randomly assigned. In either case, the ticket sales module maps the assigned colour name to a colour number (between 1 and 8) and maintains a table of the number of tickets assigned to each colour.

The first level of classification, colour, therefore divides the initial pool of tickets into 8 lots of up to 125,000 tickets (assuming all 1,000,000 tickets are sold).

At a second level of classification, called Grouping Level 1 in Table 1, each ticket may be assigned a number between 1 and 125, i.e. tickets are now grouped into lots of up to 1,000 within each colour. The value of the Grouping Level 1 variable may be chosen by the contestant at purchase, or may be randomly assigned by the ticket sales module. Similar considerations apply to Grouping Levels 2, 3 and 4, although if these are hidden variables then of course there should not be an option for the contestant to choose their values.

It is preferable to maintain a uniform distribution of tickets amongst the colours, and among the other levels of classification. In the event of a non-uniform distribution, a rebalancing step may be applied to redistribute tickets between the different colours, Level 1 groups, etc. Rebalancing may be applied at the close of ticket sales. It may also be applied while ticket sales are ongoing, for example by regularly monitoring the distribution of tickets between groups, detecting whether the distribution is skewed towards one or more of the groups, and reallocating tickets from those groups to groups which are under-represented.

The process 500 may continue to offer tickets for sale until all available tickets are sold, or until a predetermined termination time, for example 24 hours before commencement of the first elimination round.

In a process which is not shown in the figures, the ticket sales module may cause web server 128 to generate and serve, on request by a user, a summary web page containing details of each ticket purchased by that user, including its name, structured ticket number, colour, date of purchase and the like. The summary web page may include a URL for further individual web pages for each ticket, which are generated or generatable on user request.

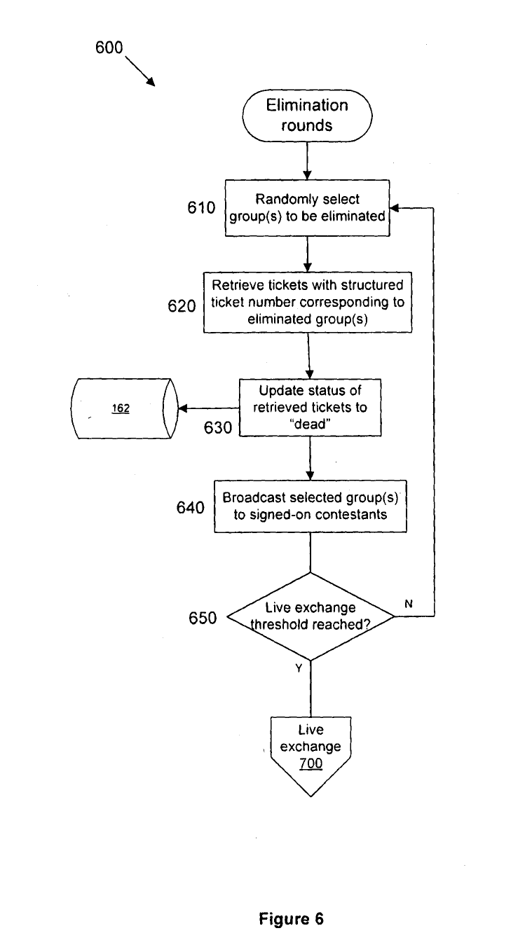

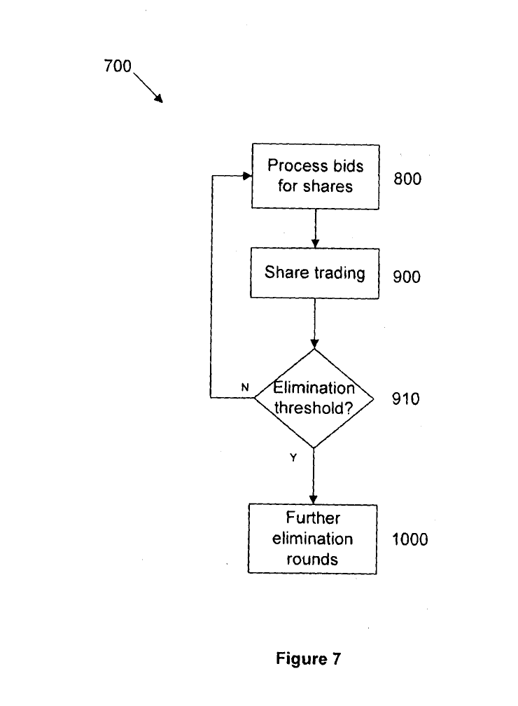

FIG. 6 illustrates an example process 600, performed by a ticket elimination module (of modules 150) for progressive elimination of tickets from the initial pool until a desired threshold is reached. In this example, the desired threshold is a threshold number of tickets to be entered into a “Live exchange” part 700 of the process 300 as will be described later. For example, the threshold number may be 800 live tickets (of the initial pool of 1,000,000 tickets).

At step 610, the ticket elimination module selects one or more groups of tickets to be eliminated. For example, in a first elimination round, the colour “purple” is randomly selected by the process 600. The list of all “purple” tickets is retrieved from database 162 (step 620). A status indicator for each purple ticket is then set to “dead” and the database 162 updated accordingly (step 630).

Typically, the ticket elimination module transmits, to one or more user devices (for example client machine 115), data representing the group of live tickets selected at step 610. On each said user device, the data representing the selected group of live tickets is processed, and data representing a structured ticket number of a ticket held by the user of the user device is retrieved. The user device then determines from the structured ticket number whether the ticket belongs to the selected group, and updates a display of the user device if the ticket belongs to the selected group.

For example, notification of the eliminated group may be posted by web server 128 (step 640), and may also be incorporated in the data stream being transmitted by streaming server 130. If a contestant is signed in, a refresh of a web page showing the status of each of their tickets may cause an updated page to be delivered, displaying to the contestant that any “purple” tickets they hold are now dead. For example, the status of each live ticket may be represented by a continually moving sine wave representing a beating heart (including sound). The eliminated ticket will be represented by a medical flatline (ie. no pulse) accompanied by a continuous beep.

The process 600 may then continue, with each further elimination round eliminating a further colour until only a single colour remains. The elimination rounds may be carried out at regular intervals, for example once per evening, such that the elimination can be simultaneously broadcast at the same time each evening, for example through TV streaming server 130 and/or by standard television broadcasting technology.

At the end of the first phase of elimination rounds, (up to) 125,000 tickets, belonging to the only non-eliminated colour, remain.

In the second phase of elimination rounds, random selections of groups from the 125 groups of Grouping Level 1 are made by the ticket elimination module (step 610), tickets belonging to those groups retrieved (step 620) and the status of those tickets updated to “dead” (step 630), in similar fashion to the selection of colours for elimination as described above. The process continues until, at the end of the second phase, 1,000 tickets remain.

In the third phase, a random selection of one of the 5 groups from Grouping Level 2 is made by the ticket elimination module. This eliminates the selected group (via steps 610, 620 and 630 as described above), leaving 800 live tickets. A check is then conducted (step 650) to determine whether this is the “live exchange” threshold, and if so the live exchange process 700 then begins.

Live Exchange

At commencement of the live exchange process 700, each of the 800 live tickets is assigned an equal number of shares by a share trading module (of modules 150), for example 100 shares per ticket. Share trading data for each live ticket is generated by the share trading module (which may be executed, at least in part, by share trading server 170) and entered into a share trading database 164.

The shares can be traded amongst contestants, including contestants whose tickets have been eliminated or contestants who have not purchased tickets, but have registered with the system 110.

The total potential value of the 100 shares may be up to half of the grand prize, for example. Ticket holders may opt to sell no shares/some shares/or all 100 shares. Astute operators will make money from share trading whether they win the first prize or not.

Only shares purchased in the winning ticket, or in a ticket which is associated with a consolation prize, share in any winnings. The proceeds from the initial sale of the 100 shares go to the holder of the ticket corresponding to those shares. In some examples, the share can continue to be traded to any identified buyer on the exchange, potentially earning traders a profit along the way.

In the live exchange process 700, the share trading module processes bids for shares at step 800, and allows for trading of the shares at step 900. The share trading module checks whether an elimination threshold has been reached, for example, a time threshold which is a predetermined time after commencement of the live exchange process 700. If the elimination threshold has not been reached, the share trading module permits further processing of bids at step 800. If the elimination threshold has been reached, further elimination rounds are carried out, by the elimination module, at step 1000.

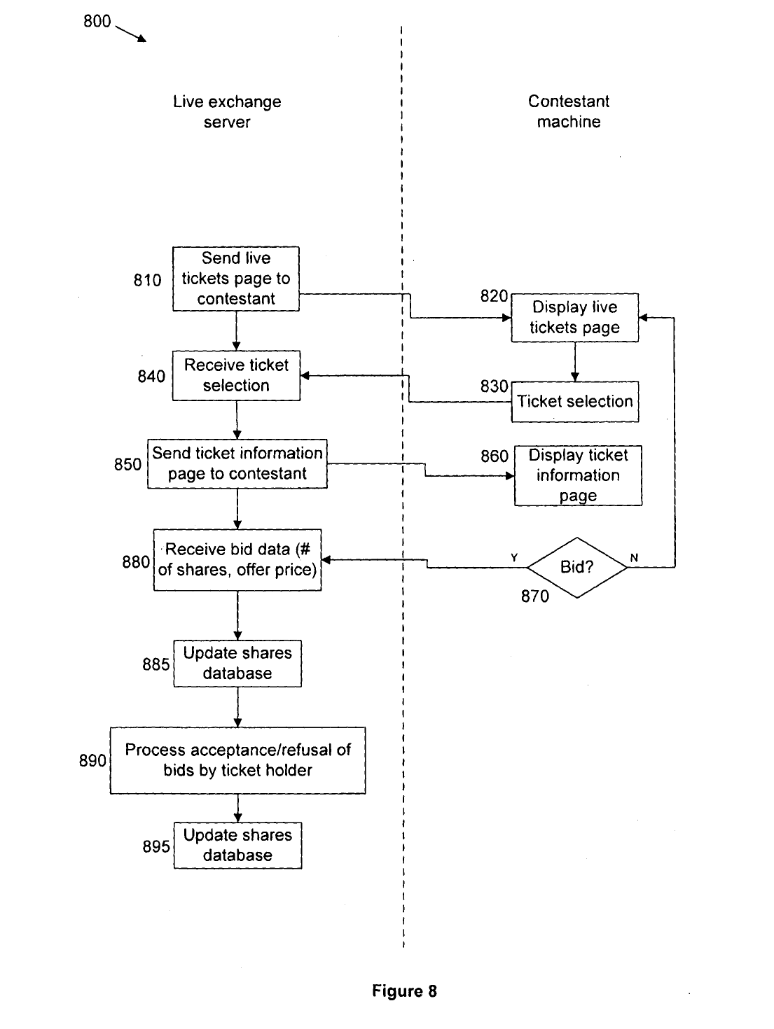

The bid processing step 800 performed by the share trading module is illustrated in more detail in FIG. 8. On request by a user, the share trading module causes web server 128 to generate a web page (using ticket data for live tickets from database 162) with a listing of the live tickets (step 810) which is displayed in the user's web browser (step 820). The listing may be in the form of a list of URLs pointing to individual “live ticket” web pages.

The live tickets page may include, for each live ticket, a current offer price (the price that the owner of the live ticket would like to obtain per share) and a current bid price (the price that potential buyers are willing to pay per share). The offer prices and bid prices may be expressed as a percentage of the ticket holder's potential winnings.

As shown in FIG. 8, the web server 128 may receive a ticket selection from a registered contestant (step 840), for example when the contestant clicks on one of the “live ticket” URLs at step 830. This causes the corresponding “live ticket” information page to be generated, sent to (step 850) and displayed in (step 860) the contestant's web browser 117.

The ticket information page, as well as including content provided by the contestant owning the selected live ticket, may include portions which are generated based on retrieval of ticket data from share trading database 164. For example, the ticket information page may include the following: the current offer price set by the contestant owning the ticket, and the value and number of shares for each bid issued by a contestant. The ticket information page may also include links to further web pages, for example a link to a profile page of each contestant who has made a bid.

The ticket information page may also include data entry fields for the contestant to enter a number of shares and a bid price for each share. If the contestant places a bid at step 870, the bid data is received by web server 128 (step 880) and the bid data for the live ticket in share trading database 164 are then updated accordingly (step 885). If no bid is made at step 870, the contestant may be returned to the “live tickets” summary page, for example.

The process 800 also includes a step 890 of processing acceptance or refusal of entered bids by the holder of the live ticket. Once processing is complete, the bid data are again updated at step 895.

Returning to FIG. 3, if the elimination threshold has been reached as described above, the process 300 proceeds to further elimination rounds 1000. The ticket elimination module selects one or more random numbers between 1 and 16, to eliminate one or more groups of tickets based on the value of the Grouping Level 3 variable (Table 1).

Each elimination may optionally be followed by the payout of a consolation prize to one or more of the eliminated tickets.

After each elimination, the process 300 may return to the live exchange process 700 to permit trading of shares in the remaining live tickets. It will be appreciated that if shares have been purchased in tickets which are eliminated, those shares lose the entirety of their value, unless there was an award of a consolation prize on the eliminated ticket in which case the shares would have a recalculated value based on the ratio of the consolation prize to the grand prize, for example (since the original share offering would have been based on the value of the grand prize). So, for example, if a ticket holder sold 40% of their potential winnings in 100 shares and won a consolation prize, the ticket holder would receive 60% of the consolation prize and each share would be allocated 0.4% of the consolation prize.

The elimination rounds 1000 may continue until only one Grouping Level 3 group of tickets remains, i.e. 50 live tickets remain (see Table 1). At this point, four further eliminations may be carried out by the ticket elimination module, each successive elimination followed by a return to the live exchange process 700, until only 10 live tickets remain.

Referring again to FIG. 3, the process 300 concludes by determining a winner of the lottery, at step 1100. For example, the final elimination 1100 may involve a random selection of a single winning ticket from the 10 remaining live tickets, or may involve one-at-a-time or few-at-a-time elimination of the remaining live tickets until a single winning ticket remains. Optionally, eliminated tickets may receive a payout of a consolation prize. The single winning ticket receives a payout of the grand prize.

Each “live ticket” web page may be at least partially generated by the contestant associated with the corresponding live ticket, for example using standard software modules or plugins (not shown) accessible via web server 128. The page may include content uploaded by the contestant, for example a video presentation or a combination of text, photos, graphics and audio. The “live ticket” page allows the contestant to pitch to potential buyers why they should buy a share in the ticket. An example pitch, from a contestant at the start of the live exchange process, may be:
“G'day, my name is Bill Smith and I've always been lucky. My ticket is already a 800 to 1 chance to win the ten million bucks. There's no guarantee but I just know my ticket has a better chance to win first prize than all the other 799 ticket holders”.

Contestants holding live tickets may sell shares in their ticket(s) at any time after the beginning of the live exchange process 700, at any time up until the final elimination 1100. Further, the offer price may be adjusted at any time by the contestant, and bidding contestants may adjust the number and/or value of their bids.

In addition, shares held by contestants may be traded to other contestants. For example, the web page for a particular live ticket may include information relating to bids which have been accepted by the ticket-holder, including the contestant details for each accepted bid. Web server 128 may generate code which causes the live ticket details page to allow accepted bids to themselves be bid on by a contestant viewing the live ticket details page. The holder of an accepted bid, when next accessing their account on system 110, would then see displayed the offer(s) from other contestant(s) for their shares, and web server 128 may generate code allowing the holder to accept or refuse any such offers. It will be realised that the ticket-holder may themselves make offers on accepted bids, such that they “buy back” their shares. For example, a ticket-holder may survive several eliminations such that they remain in the final 10 contestants, and wish to increase their potential earnings by a share buy-back.

In some embodiments, the share trading module may allow for bids by syndicates of two or more users.

There need be no restriction on the number of times a share can be traded (provided the ticket is still live) up until the competition close, nor on live ticket holders purchasing shares in other tickets. The live exchange process 700 may operate continuously, with the exception of optional lockout periods, for example during live TV broadcast time of a show associated with the lottery as mentioned above.

Typically, the live exchange server 170 will cause to be stored in shares trading database 164 a log of each transaction relating to shares in each ticket to enable a full audit trail to be maintained in the event of any disputes.

In at least some embodiments, the share trading module may require that a contestant enter their password in order to complete any action, such as a bid or an acceptance of a bid. The share trading module may also communicate with the payment processing server 125 to instruct it to store payments for shares (on acceptance of a bid) in a trust account, and may then instruct payment processing server 125 to transfer the payments from the trust account to an account of the ticket holder, after a “cooling-off” period of, for example, 3 to 5 days.

In some embodiments, the process 300 may allow holders of live tickets to enter into one or more contracts with registered contestants, called ‘If I Win’ contracts herein. Each said contract is conditional upon the ticket holder winning the grand prize or a consolation prize. If they lose, the contract is annulled. If they win the grand prize or a consolation prize the contract is binding. No ticket holder will be allowed to enter into contracts worth more than a total of 50% of their potential winnings.

Many modifications will be apparent to those skilled in the art without departing from the scope of the present invention.

The boundaries between the modules and components in the software modules 150 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the computer system 110 may be executed by a module or a portion of a module. The processes may be embodied in a machine-readable and/or computer-readable medium for configuring a computer system to execute the method. The software modules may be stored within and/or transmitted to a computer system memory to configure the computer system to perform the functions of the module.

The computer system 110 normally processes information according to a program (a list of internally stored instructions such as a particular application program and/or an operating system) and produces resultant output information via input/output (I/O) devices. A computer process typically includes an executing (running) program or portion of a program, current program values and state information, and the resources used by the operating system to manage the execution of the process. A parent process may spawn other, child processes to help perform the overall functionality of the parent process.

Because the parent process specifically spawns the child processes to perform a portion of the overall functionality of the parent process, the functions performed by child processes (and grandchild processes, etc.) may sometimes be described as being performed by the parent process.

The boundaries between databases 162, 164 are exemplary and it will be appreciated that alternative embodiments may merge the data in these databases or impose an alternative decomposition of the data records, for example over various physical databases and/or data structures.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A computer-implemented method of determining a winner of a lottery, including:
(i) generating data representing tickets purchased by users, said data including, for each ticket, a value for each of one or more variables and a status indicator indicating whether the ticket is live or dead;
(ii) selecting a group of live tickets on the basis of a value or range of values for at least one of the one or more variables;
(iii) setting the status indicator to dead for each ticket within the selected group; and
(iv) iterating over steps (ii) and (iii) to progressively reduce the number of live tickets in groups until one or more threshold numbers of live tickets is reached and/or until a single live ticket remains.

2. The computer-implemented method according to claim 1, wherein the variables include categorical variables.

3. The computer-implemented method according to claim 1, including generating, for each ticket, a structured ticket number from the values of said variables.

4. The computer-implemented method according to claim 1, including transmitting, to one or more user devices, data representing the group of live tickets selected in step (ii).

5. The computer-implemented method according to claim 4, including processing, on each said user device, the data representing the selected group of live tickets.

6. The computer-implemented method according to claim 5, including retrieving data representing a structured ticket number of a ticket held by the user of the user device, determining from the structured ticket number whether the ticket belongs to the selected group, and updating a display of the user device if the ticket belongs to the selected group.

7. The computer-implemented method according to claim 1, including, on reaching a first threshold of the one or more thresholds, generating share data corresponding to shares in each live ticket.

8. The computer-implemented method according to claim 7, wherein the share data includes bid data corresponding to zero or more bids from users.

9. The computer-implemented method according to claim 8, including receiving bid data from one or more users for shares.

10. The computer-implemented method according to claim 9, wherein the one or more users includes a syndicate of users.

11. The computer-implemented method according to claim 1, wherein steps (ii) and (iii) are carried out at predetermined intervals after a start time.

12. The computer-implemented method according to claim 1, including paying out a prize to a user after reaching at least one prize threshold of the one or more thresholds.

13. The computer-implemented method according to claim 12, wherein the at least one prize threshold includes at least one consolation prize threshold, one or more consolation prizes being paid out to users associated with one or more dead tickets on reaching said consolation prize threshold.

14. The computer-implemented method according to claim 13, wherein the consolation prize thresholds correspond to the number of live tickets after one or more of the progressive reductions of the number of live tickets.

15. The computer-implemented method according to claim 1, including, for at least some users associated with one or more live tickets, generating a user page including ticket data for each said user.

16. The computer-implemented method according to claim 15, wherein the at least some users are users associated with live tickets when a second threshold number of live tickets is reached.

17. The computer-implemented method according to claim 16, wherein the second threshold is the same as the first threshold.

18. The computer-implemented method according to claim 16, including populating the user page with content received from the user.

19. The computer-implemented method according to claim 1, including generating contract data representing a legal agreement between two users.

20. The computer-implemented method according to claim 19, wherein the contract data includes a contract validity flag.

21. The computer-implemented method according to claim 20, including setting the contract validity flag to false if one of the users is not the winner of the lottery.

22. The system for determining a winner of a lottery, including at least one computer processor configured to perform the method of claim 1.

23. A system for determining a winner of a lottery, including:
means for generating data representing tickets purchased by users, said data including, for each ticket, a value for each of one or more variables and a status indicator indicating whether the ticket is live or dead; and
means for iteratively:
selecting a group of live tickets on the basis of a value or range of values for at least one of the one or more variables; and
setting the status indicator to dead for each ticket within the selected group, to thereby progressively reduce the number of live tickets in groups until one or more threshold numbers of live tickets is reached and/or until a single live ticket remains.

24. The system according to claim 23, including means for generating share data corresponding to shares in each live ticket on reaching a first threshold of the one or more thresholds.

25. The system according to claim 24, wherein the share data includes bid data corresponding to zero or more bids from users.

26. The system according to claim 25, including means for receiving bid data from one or more users for shares.

27. The system according to claim 26, wherein the one or more users includes a syndicate of users.

28. The computer program product for determining a winner of a lottery, including program instructions which, when executed, cause one or more computer processors to perform the method of claim 1.

29. The computer readable data storage device, including the computer program product of claim 28.
